(19) United States
(12) Patent Application Publication
(10) Pub. No.: US 2006/0028510 A1
(43) Pub. Date: Feb. 9, 2006

(54) Method of fabricating an inkjet print head using a photo-curable resin composition

(76) Inventors: Byung-Ha Park, Suwon-si (KR); Myong-Jong Kwon, Suwon-si (KR); Nam-Kyun Kim, Ansan-si (KR)

Correspondence Address: STANZIONE & KIM, LLP, 919 18TH STREET, N.W., SUITE 440, WASHINGTON, DC, 20006, US

(21) Appl. No.: 11/047,586

(22) Filed: Feb. 2, 2005

(30) Foreign Application Priority Data
Aug. 5, 2004 (KR) 2004-61839

(51) Int. Cl. B41J 2/05

(52) U.S. Cl. 347/63

(57) ABSTRACT

A method of fabricating an inkjet print head including forming an energy-generating element to eject ink on a substrate. A chamber layer and a nozzle layer having a nozzle corresponding to the energy-generating element are formed on the substrate. At least one layer of the chamber layer and the nozzle layer is formed using a photo-curable resin composition containing a photo-radical generator, an epoxy resin curable by reaction with a radical, and a non-photo reactive solvent.

### CROSS-REFERENCE TO RELATED APPLICATIONS

This application claims the benefit under 35 U.S.C. § 119 of Korean Patent Application No. 2004-61839, filed Aug. 5, 2004, the disclosure of which is incorporated herein in its entirety.

### BACKGROUND OF THE INVENTION

1. Field of the Invention

The present general inventive concept relates to a method of fabricating an inkjet print head and, more particularly, to a method of fabricating an inkjet print head using a photo-curable resin composition.

2. Description of the Related Art

An inkjet printer is a device for printing an image by ejecting fine droplets of ink to a desired position on a recording medium. Inkjet printers have been widely used due to their inexpensive price and characteristics capable of printing numerous colors at a high resolution.

The inkjet printer includes an inkjet head and an ink container connected to the inkjet head. The inkjet head includes a chamber layer for forming ink flow paths and ink chambers, heat-generating resistors located in the ink chambers, and a nozzle layer provided with nozzles corresponding to the heat-generating resistors. The ink stored in the ink container is supplied into the ink chambers through an ink-feed hole and along the ink flow paths. When the heat-generating resistors are energized, the heat-generating resistors generate heat to create bubbles in the ink supplied into the ink chambers. The bubbles are expanded to apply pressure to the ink supplied into the ink chambers, thereby ejecting the ink toward an exterior through the nozzles by the pressure created.

The inkjet head should meet various conditions in order to operate with stability and reliability. In particular, the chamber layer and the nozzle layer should have a corrosion resistance since they are always in contact with the ink, i.e., an aqueous material, and should have a high mechanical strength for structural integrity. Furthermore, the layers should have strong adhesive properties with respect to a substrate.

In order to meet the above-mentioned conditions, research on forming the chamber layer and the nozzle layer using a photo-curable resin composition has been performed. For example, U.S. Pat. No. 5,478,606 discloses forming the ink flow paths and ink ejection outlets by forming a photosensitive coating resin layer using a solution containing an epoxy resin and a cationic photopolymerization initiator. The cationic photopolymerization initiator generates a cation by exposure, and the cation initiates polymerization of the epoxy resin. However, during formation of the photosensitive coating resin layer, when the cation comes in contact with the heat-generating resistors generally formed of metal, the heat-generating resistors may be damaged. Therefore, a passivation layer should be formed on the heat-generating resistors before forming the photosensitive coating resin layer.

### SUMMARY OF THE INVENTION

The present general inventive concept provides a method of fabricating an inkjet print head including forming a chamber layer and/or nozzle layer having strong adhesion to a base substrate, mechanical strength, and a corrosion resistance to ink using a photo-curable resin composition which does not damage a heat-generating resistor.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept may be achieved by providing a method of fabricating an inkjet print head, the method including forming energy-generating elements to eject ink on a substrate. A chamber layer and a nozzle layer having nozzles corresponding to the energy-generating elements are formed on the substrate. At least one layer of the chamber layer and the nozzle layer is formed using a photo-curable resin composition containing a photo-radical generator, an epoxy resin curable by reaction with a radical, and a non-photo reactive solvent.

The radical may be a hydrogen radical having a high reactivity with the epoxy resin. The photo-radical generator may be an acetophenone-based material, and the acetophenone-based material may be represented by the following chemical formula.

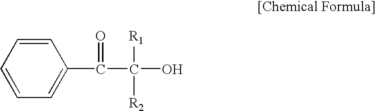

In the foregoing formula, R1 and R2 may be hydrogen, alkyl radicals of C1 to C5, alkoxy radicals of C1 to C5, or phenyl radicals, regardless of what the other one of them is.

The epoxy resin may contain at least one of a difunctional epoxy resin and a multifunctional epoxy resin. In particular, the epoxy resin may contain both the difunctional epoxy resin and the multifunctional epoxy resin. Therefore, a layer formed using the photo-curable resin composition can have improved tensile strength and elastomeric properties, improved resolution, and a minimal solvent swelling property.

The difunctional epoxy resin may be at least one epoxy resin selected from a group including bisphenol A type, bisphenol F type, hydroquinone type, and resorcinol type epoxy resins. The multifunctional epoxy resin may be a novolak type epoxy resin.

Forming the chamber layer and/or the nozzle layer using the photo-curable resin composition may include forming a photo-curable resin layer on the substrate using the photo-curable resin composition, selectively exposing the photo-curable resin layer, and removing an unexposed portion of the exposed photo-curable resin layer.

Alternatively, the chamber layer and the nozzle layer may be formed at the same time and in the same process by forming an ink flow path structure having nozzles corresponding to the energy-generating elements on the substrate. Forming the ink flow path structure may include forming a sacrificial mold layer covering the energy-generating elements, forming a photo-curable resin layer covering the sacrificial mold layer using the photo-curable resin composition, selectively exposing the photo-curable resin layer, and removing an unexposed portion of the exposed photo-curable resin layer.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIGS. 1A, 1B, 1C, 1D and 1E are cross-sectional views illustrating a method of fabricating an inkjet print head in accordance with an embodiment of the present general inventive concept;

FIGS. 2A, 2B and 2C are cross-sectional views illustrating a method of fabricating an inkjet head in accordance with another embodiment of the present general inventive concept; and

FIG. 3 is a photograph depicting a patterned photo-curable resin layer fabricated according to an example of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

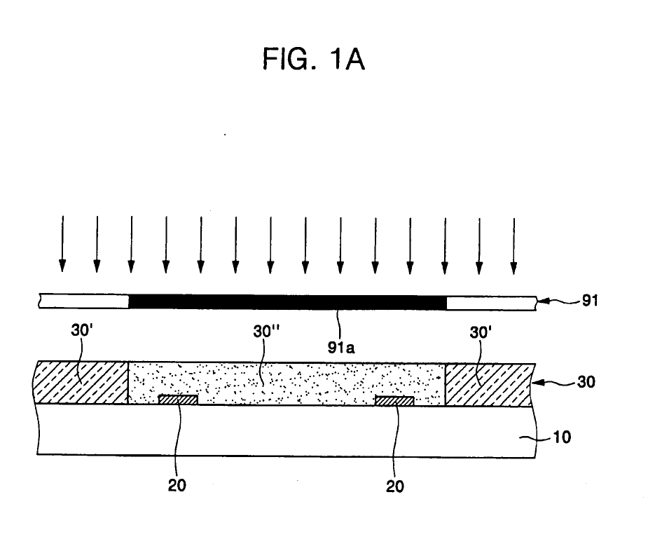

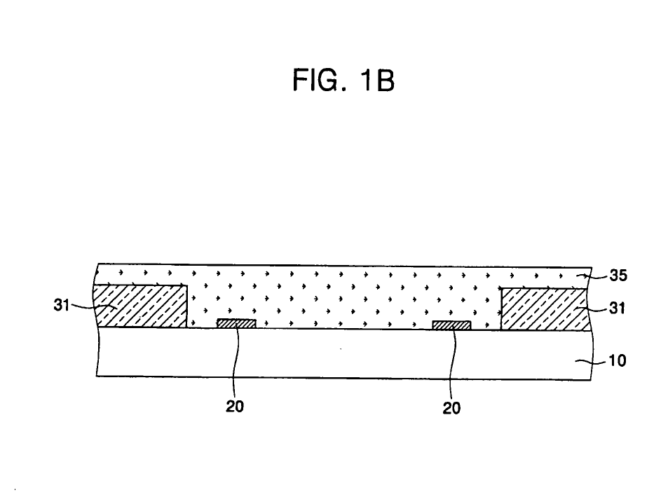

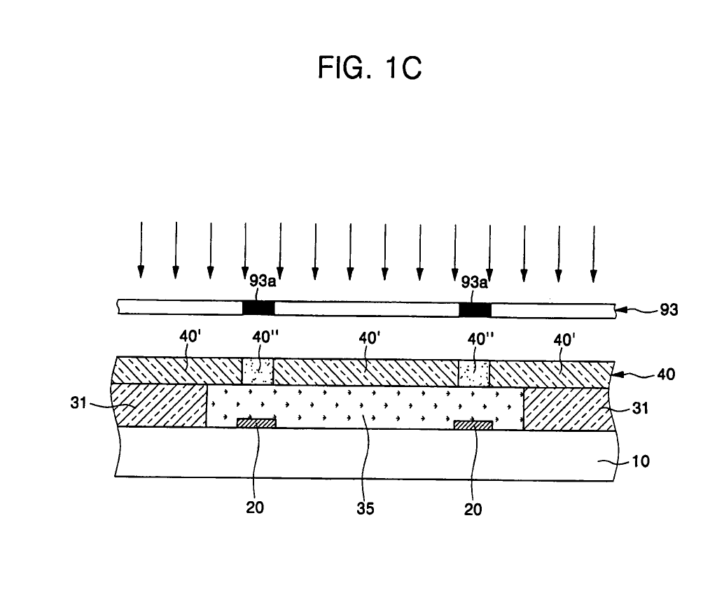

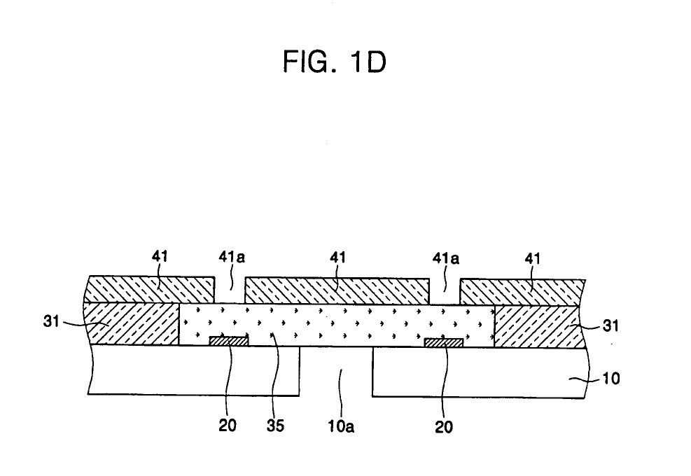

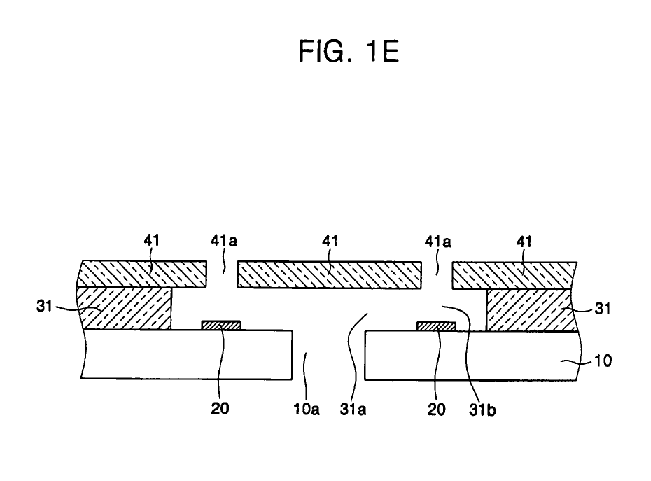

FIGS. 1A, 1B, 1C, 1D and 1E are cross-sectional views illustrating a method of fabricating an inkjet print head in accordance with an embodiment of the present general inventive concept.

Referring to FIG. 1A, energy-generating elements 20 to eject ink are formed on a substrate 10. The substrate 10 may be a silicon substrate having a thickness of about 500 μm, and the substrate 10 may be mass produced. The energy-generating elements 20 may be a thermal resistor or a piezoelectric material. Furthermore, the thermal resistor may include a high resistance metal layer and a low resistance metal layer pattern contacted with both ends of the high resistance metal layer. The high resistance metal layer may be an alloy layer of tantalum-aluminum, and the low resistance metal layer may be a gold layer. A passivation layer (not shown) may be formed on the energy-generating elements 20 to protect lower structures including the energy-generating elements 20. Alternatively, the passivation layer may be omitted due to reasons described below.

A first photo-curable resin layer 30 is formed on the substrate, at which the energy-generating elements 20 are formed. The first photo-curable resin layer 30 may be formed by coating a photo-curable resin composition on the substrate 10 using a spin coating method, a roll coating method, or other methods. The photo-curable resin composition contains a photo-radical generator (PRG), an epoxy resin curable by reaction with a radical, and a non-photo reactive solvent.

The photo-radical generator is a photo-initiator capable of generating the radical by exposure, and the radical generated by the exposure is a hydrogen radical having high reactivity with the epoxy resin. The photo-radical generator may be an acetophenone-based material. Furthermore, the acetophenone-based material may be a material represented by the following chemical formula 1.

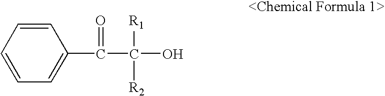

In the foregoing formula, R1 and R2 may be hydrogen, alkyl radicals of C1 to C5, alkoxy radicals of C1 to C5, or phenyl radicals, regardless of what the other one of them is.

In the foregoing formula, both R1 and R2 may also be a methyl radical. That is, the photo-radical generator is 2-hydroxy-2-methyl-1-phenylpropan-1-one (HMPP), which is capable of generating a hydrogen radical having high reactivity.

The epoxy resin may contain at least one of a difunctional epoxy resin and a multifunctional epoxy resin. The difunctional epoxy resin refers to a resin having two epoxy radicals, and the multifunctional epoxy resin refers to a resin having at least three epoxy radicals. The epoxy resin may contain both the difunctional epoxy resin and the multifunctional epoxy resin. As a result, the first photo-curable resin layer 30 can have improved tensile strength and elastomeric properties by virtue of containing the difunctional epoxy resin. The first photo-curable resin layer 30 may also have improved resolution and a minimal solvent swelling property by virtue of containing the multifunctional epoxy resin, thereby increasing cross-link density.

The difunctional epoxy resin may be a bisphenol A type, a bisphenol F type, a hydroquinone type, or a resorcinol type epoxy resin. In addition, the multifunctional epoxy resin may be a novolak type epoxy resin.

In particular, the epoxy resin may contain the bisphenol A type epoxy resin as the difunctional epoxy resin, and the novolak type epoxy resin as the multifunctional epoxy resin. Furthermore, the photo-curable resin composition contains the photo-radical generator represented as the chemical formula 1, a diglycidyl ether bisphenol A epoxy resin, and a novolak epoxy resin. The diglycidyl ether bisphenol A epoxy resin is available from Shell Chemicals, as a trade name entitled “EPON 828” and “EPON SU-8”; Dow Chemical Company, as a trade name “DER-332” and “DER-334”; and Union Carbide Corporation, as a trade name “ERL-4201” and “ERL-4289”, etc. In addition, the novolak epoxy resin is available from Dow Chemical Company, as a trade name entitled “DEN-431” and “DEN-439”, etc.

The photo-curable resin composition may contain an epoxy resin of about 5 to 70 wt % and a photo-radical generator of about 2 to 10 wt % with respect to a total weight of the photo-curable resin composition. When the epoxy resin contains the difunctional epoxy resin and the multifunctional epoxy resin, the photo-curable resin composition may contain the difunctional epoxy resin of about 5 to 50 wt % with respect to the total weight of the photo-curable resin composition and the multifunctional epoxy resin of about 0.5 to 20 wt % with respect to the total weight of the photo-curable resin composition. In various embodiments of present general inventive concept, the photo curable resin composition may contain the difunctional epoxy resin of about 10 to 20 wt % with respect to the total weight of the photo-curable resin composition and the multifunctional epoxy resin of about 1 to 5 wt % with respect to the total weight of the photo-curable resin composition.

The non-photo reactive solvent may be gamma-butyrolactone (GBL), cyclopentanone, C1-6 acetate, tetrahydrofuran (THF), xylene, or a mixture thereof. The photo-curable resin composition may contain a non-photo reactive solvent of about 10 to 40 wt % with respect to the total weight.

Furthermore, the photo-curable resin composition may further contain an additive. The additive may be a silane coupling agent to improve adhesion with the substrate 10, a dye to adjust an extinction coefficient of the first photo-curable resin layer 30, a surfactant, a filler, and/or a viscosity modifier.

Soft baking may be performed at a low temperature in order to remove a solvent component contained in the first photo-curable resin layer 30 formed on the substrate 10. The first photo-curable resin layer 30 is selectively exposed by irradiating light on the baked first photo-curable resin layer 30 using a photo-mask 91, at which an ink flow path pattern 91a is formed. In the exposure, the light may be UV or DUV (Deep UV) rays having a wavelength equal to or less than about 400 nm. A light source to emit the light may be a mercury lamp (365 nm), a KrF laser (248 nm), or an ArF laser (193 nm).

The exposed first photo-curable resin layer 30 is provided with an unexposed portion 30″ corresponding to the ink flow path pattern 91a and an exposed portion 30′ corresponding to remaining portions except the ink flow path pattern 91a. The exposed portion 30′ generates a radical from the photo-radical generator when it is irradiated with the light, the generated radical reacts with an epoxy radical of the epoxy resin to generate ring-opening polymerization between the epoxy radicals, and thus the epoxy resin is cross-linked. Consequently, the exposed portion 30′ of the first photo-curable resin layer 30 is cured due to the cross-link of the epoxy resin. In the unexposed portion 30″ of the first photo-curable resin layer 30, the epoxy resin is not cross-linked and remains a monomer or an oligomer.

The radical generated by irradiating the first photo-curable resin layer 30 does not damage a metal forming the energy-generating elements 20 located under the first photo-curable resin layer 30. Therefore, in the present embodiment, a passivation layer may not be necessary to protect the energy-generating elements 20, unlike the conventional technology.

A post exposure bake may be performed. The post exposure bake may be performed at a temperature of about 60 to 95° C.

Referring to FIG. 1B, the unexposed portion (30″ in FIG. 1A) of the first photo-curable resin layer (30 in FIG. 1A) is removed using a developer. Post-curing may then be performed in order to further cure the exposed portion 30′ and remove the developer in which a residue may remain. As a result, a chamber layer 31 is formed on the substrate 10, which functions as sidewalls of ink flow paths and ink chambers. The chamber layer 31 is formed using a photo-curable resin composition including an epoxy resin and a photo-radical generator, thereby having an increased mechanical strength due to high cross-link density, increased corrosion resistance to the ink, and strong adhesion with the substrate 10.

Subsequently, a sacrificial layer 35 is formed on the substrate 10 to cover the chamber layer 31 and fill the ink flow paths. The sacrificial layer 35 may be a positive photo-resist.

Referring to FIG. 1C, the sacrificial layer 35 is etched to expose a top surface of the chamber layer 31. Etching the sacrificial layer 35 may be performed by a planarization process such as a chemical mechanical polishing method. A thickness of the chamber layer 31 may be decreased to an extent in the process of etching the sacrificial layer 35.

A second photo-curable resin layer 40 is formed on the chamber layer 31 and the sacrificial layer 35. The second photo-curable resin layer 40 may be formed by coating the photo-curable resin composition using a spin coating method, a roll coating method, or other methods. Soft baking may be performed at a low temperature in order to remove a solvent component contained in the second photo-curable resin layer 40. The second photo-curable resin layer 40 is selectively exposed by irradiating light on the baked second photo-curable resin layer 40 using a photo-mask 93, at which a nozzle pattern 93a is formed as a mask. Consequently, the exposed second photo-curable resin layer 40 is provided with an unexposed portion 40″ corresponding to the nozzle pattern 93a and an exposed portion 40′ corresponding to remaining portions except the nozzle pattern 93a. The exposed portion 40′ is a portion cured by a cross-link of the epoxy resin, and the unexposed portion 40″ is a portion where the epoxy resin is not cross-linked and remains a monomer or an oligomer. A post exposure bake may be performed.

Referring to FIG. 1D, the unexposed portion (40″ in FIG. 1C) of the second photo-curable resin layer (40 in FIG. 1C) is removed using a developer. Then, post-curing may be performed in order to further cure the exposed portion 40′, and to remove the developer in which a residue may remain. As a result, a nozzle layer 41 having nozzles 41a is formed on the chamber layer 31 and the sacrificial layer 35.

Alternatively, the nozzle layer 41 may be formed by a method of bonding a nozzle plate to the chamber layer 31, after the nozzle plate is formed by a composite plating method using a metal material, such as nickel.

Subsequently, the substrate 10 is selectively etched to form an ink-feed hole 10a extending through the substrate 10.

Referring to FIG. 1E, the sacrificial layer (35 in FIG. 1D) is removed through the ink-feed hole 10a using an appropriate solvent. As a result, ink flow paths 31a and ink chambers 31b are formed in a region from which the sacrificial layer 35 is removed.

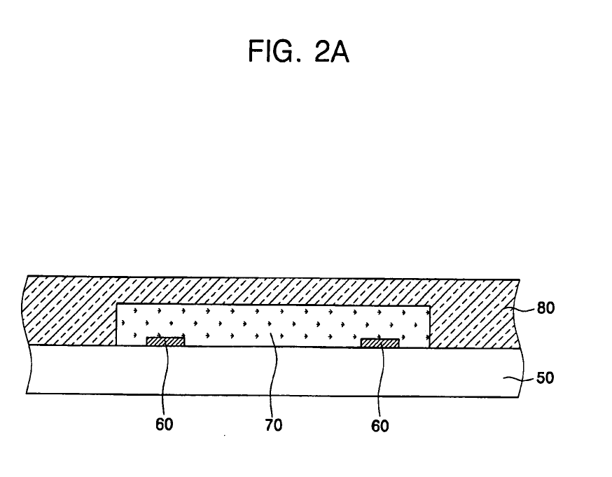

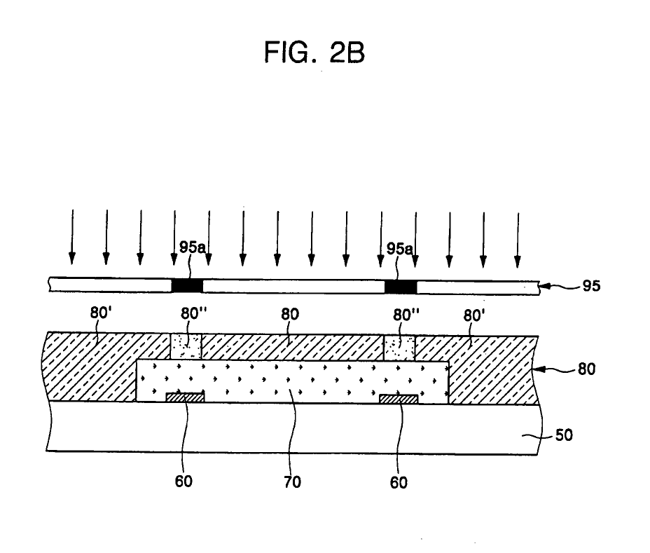

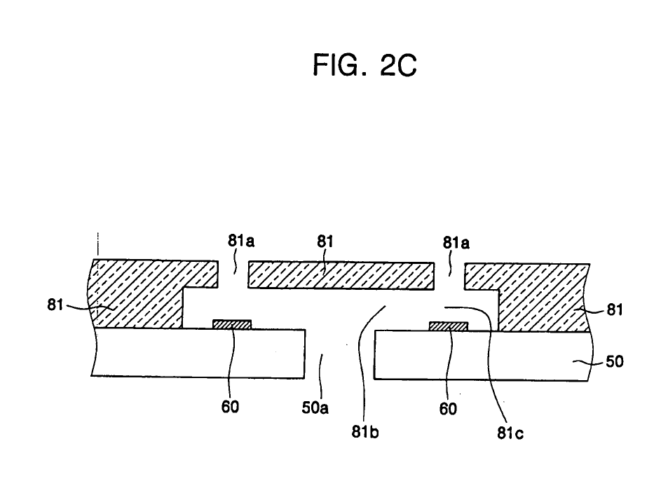

FIGS. 2A, 2B and 2C are cross-sectional views illustrating a method of fabricating an inkjet print head in accordance with another embodiment of the present general inventive concept. In accordance with the present embodiment illustrated in FIGS. 2A to 2C, a chamber layer and a nozzle layer are simultaneously formed by the same process.

Referring to FIG. 2A, energy-generating elements 60 are formed on a substrate 50. A sacrificial mold layer 70 is formed on the substrate 50, at which the energy-generating elements 60 are formed. The sacrificial mold layer 70 may be formed using a positive photo-resist.

A photo-curable resin layer 80 to cover the sacrificial mold layer 70 is formed on the sacrificial mold layer 70. The photo-curable resin layer 80 may be formed by coating a photo-curable resin composition on the substrate 50 using a spin coating method, a roll coating method, or other methods. The photo-curable resin composition contains a photo-radical generator, an epoxy resin curable by reaction with the radical, and a non-photo reactive solvent, similar to other embodiments.

Referring to FIG. 2B, the photo-curable resin layer 80 is selectively exposed by irradiating light on the photo-curable resin layer 80 using a photo-mask 95 at which a nozzle pattern 95a is formed as a mask. As a result, the photo-curable resin layer 80 is provided with an unexposed portion 80″ corresponding to the nozzle pattern 95a and an exposed portion 80′ corresponding to remaining portions except the nozzle pattern 95a. The exposed portion 80′ is a portion cured by a cross-link of the epoxy resin, and the unexposed portion 80″ is a portion where the epoxy resin is not cross-linked and remains a monomer or an oligomer.

Referring to FIG. 2C, the unexposed portion (80″ in FIG. 2B) of the photo-curable resin layer (80 in FIG. 2B) is removed using a developer. As a result, an ink flow path structure 81 having nozzles 81a corresponding to the energy-generating elements 60 is formed.

Subsequently, the substrate 50 is selectively etched to form an ink-feed hole 50a extending through the substrate 50, and the sacrificial mold layer (70 in FIG. 2B) is removed through the ink-feed hole 50a using an appropriate solvent. Ink flow paths 81b and ink chambers 81c are formed in a region from which the sacrificial mold layer is removed. The ink flow path structure functions as sidewalls of the ink flow paths 81b and the ink chambers 81c. The ink flow path structure also has nozzles 81a from which ink is ejected. Therefore, the ink flow path structure 81 corresponds to the chamber layer (31 in FIG. 1E) and the nozzle layer (41 in FIG. 1E) in the previous embodiment.

The foregoing embodiments describe an inkjet print head of a top shooting type, however is should be understood that the present general inventive concept is not limited thereto. Therefore, it will be apparent that various other types of ink flow path structures, in which ink flows (e.g., ink flow path structures of a bottom shooting type inkjet print head or a side shooting type inkjet print head) may be formed according to the foregoing embodiments.

Hereinafter, the present general inventive concept will be described with reference to the following example.

### EXAMPLE

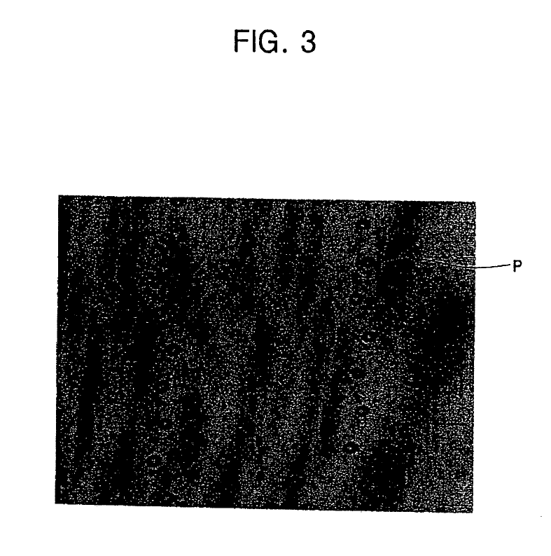

120 g of a mixture of a diglycidyl ether bisphenol A epoxy resin, an ortho-cresol novolak epoxy resin, and 10 ml of 2-hydroxy-2-methyl-1-phenylpropane-1-one (HMPP) are added to 50 ml of xylene in order to prepare a photo-curable resin composition. The photo-curable resin composition is spin coated on a substrate in 40 seconds at 2300 rpm to form a photo-curable resin layer. After pre-baking the photo-curable resin layer for 8 minutes at 95° C., the photo-curable resin layer is exposed using a photo-mask under a condition of 260 mJ/cm². Baking is then performed after exposing for 4 seconds at 95° C., and development is performed for 1 minute using propylene glycol monomethyl ether acetate (PGMEA) as a developer. The photo-curable resin layer is patterned by rinsing for 1 minute using isopropyl alcohol (IPA). The patterned photo-curable resin layer is depicted in FIG. 3. A part designated as P represents an unexposed region.

As can be seen from the foregoing, a method of fabricating an inkjet print head in accordance with the present general inventive concept is capable of forming a chamber layer and a nozzle layer having a high mechanical strength, a corrosion resistance to ink, and strong adhesion to a substrate due to high cross-link density, by forming the chamber layer and/or the nozzle layer using a photo-curable resin composition containing a photo-radical generator and an epoxy resin curable by reaction with a radical.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of fabricating an inkjet print head, comprising:
forming an energy-generating element to eject ink on a substrate; and
forming a chamber layer and a nozzle layer having a nozzle corresponding to the energy-generating element on the substrate;
wherein at least one layer of the chamber layer and the nozzle layer is formed using a photo-curable resin composition containing a photo-radical generator, an epoxy resin curable by reaction with a radical, and a non-photo reactive solvent.

2. The method according to claim 1, wherein the radical is a hydrogen radical.

3. The method according to claim 1, wherein the photo-radical generator is an acetophenone-based material.

4. The method according to claim 3, wherein the acetophenone-based material is represented as the following chemical formula: 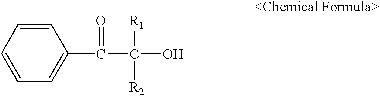
where, R1 and R2 are hydrogen, alkyl radicals of C1 to C5, alkoxy radicals of C1 to C5, or phenyl radicals, regardless of what the other one is.

5. The method according to claim 1, wherein the epoxy resin contains at least one of a difunctional epoxy resin and a multifunctional epoxy resin.

6. The method according to claim 5, wherein the difunctional epoxy resin is at least one epoxy resin selected from a group consisting of bisphenol A type, bisphenol F type, hydroquinone type, and resorcinol type epoxy resins.

7. The method according to claim 5, wherein the multifunctional epoxy resin is a novolak type epoxy resin.

8. The method according to claim 5, wherein the epoxy resin contains a diglycidyl ether bisphenol A epoxy resin as the difunctional epoxy resin and a novolak epoxy resin as the multifunctional epoxy resin.

9. The method according to claim 1, wherein the photo-curable resin composition contains the epoxy resin of about 5 to 70% by weight with respect to a total weight of the photo-curable resin composition.

10. The method according to claim 9, wherein the epoxy resin includes a difunctional epoxy resin and a multifunctional epoxy resin, and the photo-curable resin composition contains the difunctional epoxy resin of about 5 to 50% and the multifunctional epoxy resin of about 0.5 to 20% by weight with respect to the total weight of the photo-curable resin composition.

11. The method according to claim 1, wherein the photo-curable resin composition contains the photo-radical generator of about 2 to 10% by weight with respect to a total weight of the photo-curable resin composition.

12. The method according to claim 1, wherein forming at least one layer of the chamber layer and the nozzle layer using the photo-curable resin composition comprises:
forming a photo-curable resin layer on the substrate using the photo-curable resin composition; and
selectively exposing the photo-curable resin layer and removing an unexposed portion of the exposed photo-curable resin layer.

13. The method according to claim 1, wherein forming the chamber layer and the nozzle layer comprises:
forming the chamber layer on the substrate;
forming a sacrificial layer to cover the chamber layer; and
exposing a top surface of the chamber layer by etching the sacrificial layer,
wherein the nozzle layer is formed on the chamber layer, of which the top surface is exposed.

14. The method according to claim 13, further comprising: after forming the nozzle layer,
forming an ink-feed hole extending through the substrate by etching the substrate; and
removing the sacrificial layer through the ink-feed hole.

15. The method according to claim 1, wherein forming the chamber layer and the nozzle layer on the substrate comprises:
forming a sacrificial mold layer to cover the energy-generating element;
forming a photo-curable resin layer to cover the sacrificial mold layer using the photo-curable resin composition;
selectively exposing the photo-curable resin layer; and
forming an ink flow path structure having a nozzle corresponding to the energy-generating element by removing an unexposed portion of the exposed photo-curable resin layer.

16. The method according to claim 15, further comprising: after forming the ink flow path structure,
forming an ink-feed hole extending through the substrate by etching the substrate; and
removing the sacrificial mold layer through the ink-feed hole.

17. A method of fabricating an inkjet head, the method comprising:
forming a chamber layer on a substrate having one or more pressure generating elements disposed thereon, wherein forming the chamber layer comprises:
applying a first photo-curable resin layer of a photo-curable resin composition containing at least a photo radical generator and an epoxy resin, and
exposing the first photo-curable resin layer to define an ink flow path and curing an exposed portion of the first photo-curable resin layer so that the epoxy resin reacts with a radical provided by the photo radical generator; and
forming a nozzle layer having one or more nozzles to correspond to the one or more pressure-generating elements.

18. The method according to claim 17, wherein the photo-curable resin composition further contains a non-photo reactive solvent.

19. The method according to claim 18, wherein the non-photo reactive solvent is selected from a group consisting of gamma-butyrolactone, cyclopentanone, C1-6 acetate, tetrahydrofuran, xylene, or a mixture thereof.

20. The method according to claim 17, wherein forming the nozzle layer comprises:
forming a second photo-curable resin layer of the photo-curable resin composition; and
exposing the second photo-curable resin layer according to a nozzle mask so that the epoxy resin reacts with a radical provided by the photo radical generator in exposed portions of the second photo-curable resin layer.

21. The method according to claim 20, wherein forming the nozzle layer further comprises, before forming the second photo-curable resin layer, forming a sacrificial mold layer on the chamber layer.

22. The method according to claim 21, further comprising:
after forming the sacrificial mold layer, planarizing the sacrificial mold layer so that a top surface of the sacrificial mold layer is in the same plane as a top surface of the chamber layer.

23. The method according to claim 21, further comprising:
etching the substrate from a bottom surface to form an ink-feed hole extending through the substrate and dissolving the sacrificial mold through the ink feed-hole.

24. The method according to claim 20, wherein the one or more nozzles correspond to an unexposed portion of the second photo-curable resin layer, which is removed by rinsing with a solvent.

25. The method according to claim 17, wherein forming the nozzle layer comprises bonding a metal nozzle layer to the chamber layer using a composite plating method.

26. The method according to claim 17, wherein the epoxy resin contains at least one of a difunctional epoxy resin and a multifunctional epoxy resin.

27. The method according to claim 26, wherein the difunctional epoxy resin is selected from a group consisting of bisphenol A type, bisphenol F type, hydroquinone type, and resorcinol type.

28. The method according to claim 26, wherein the multifunctional epoxy resin comprises a novolak type epoxy resin.

29. The method according to claim 17, wherein the one or more pressure generating elements comprise one or more thermal resistors including a pattern of a high resistance metal and a low resistance metal.

30. The method according to claim 29, wherein a passivation layer is not formed over the one or more thermal resistors before forming the chamber layer on the substrate.

31. The method according to claim 17, wherein the first photo-curable resin layer does not corrode after coming in contact with ink.

32. The method according to claim 17, wherein the photo-radical generator is a photo initiator to generate the radical when exposed to light in a predetermined range of wavelengths, the radical having a high reactivity with respect to the epoxy resin.

33. The method according to claim 17, wherein the radical provided by the photo radical generator is a hydrogen radical.

34. The method according to claim 17, wherein the radical is an acetophenone-based material and is represented by the following chemical formula:

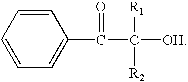

35. The method according to claim 34, wherein R1 and R2 are a methyl radical and the photo-radical generator is 2-hydroxy-2-methyl-1-phenylpropan-1-one (HMPP) and generates a hydrogen radical.

36. The method according to claim 17, wherein the photo-curable resin composition contains the epoxy resin of about 5 to 70 by weight and the photo-radical generator of about 2 to 10 by weight with respect to a total weight of the photo-curable resin composition.

37. The method according to claim 36, wherein the epoxy resin contains a difunctional epoxy resin of about 5 to 50 by weight and a multifunctional epoxy resin of about 0.5 to 20 by wieght with respect to the total weight of the photo-curable resin composition.

38. The method according to claim 37, wherein the epoxy resin contains the difunctional epoxy resin of about 10 to 20 by weight and the multifunctional epoxy resin of about 1 to 5 weight with respect to the total weight of the photo-curable resin composition.

39. The method according to claim 36, wherein the photo-curable resin composition further contains at least one of a silane coupling agent to improve adhesion with the substrate, a dye to adjust an extinction coefficient of the first photo-curable layer, a surfactant, a filler, and a viscosity modifier.

40. The method according to claim 17, wherein the radical provided by the photo-radical generator reacts with an epoxy radical of the epoxy resin in an exposed portion of the first photo-curable resin layer.

41. The method according to claim 40, wherein the radical provided by the photo-radical generator reacts with an epoxy radical to cross link the epoxy resin creating a ring-opening polymerization.

42. The method according to claim 41, wherein an unexposed portion is not cross-linked and the unexposed portion is removed by patterning.

43. A method of fabricating an inkjet head, the method comprising:
forming an ink flow structure including a chamber layer and a nozzle layer on a substrate having one or more pressure generating elements disposed thereon, wherein the ink flow structure is formed of a photo-curable resin layer of a photo-curable resin composition containing at least a photo radical generator and an epoxy resin;
exposing the first photo-curable resin layer and curing an exposed portion of the first photo-curable resin layer so that the epoxy resin reacts with a radical provided by the photo radical generator.

44. The method according to claim 43, further comprising:
before forming the ink flow structure, forming a sacrificial mold layer on the substrate having the one or more pressure generating elements disposed thereon.

45. The method according to claim 43, wherein exposing the photo-curable resin layer comprises masking the photo-curable resin layer according to a nozzle pattern so that the epoxy resin reacts with the radical provided by the photo-radical generator and patterning the photo-curable resin layer.

46. The method according to claim 43, further comprising forming one or more nozzles corresponding to the one or more pressure generating elements by removing an unexposed portion of the photo-curable resin layer using an alcohol.

47. The method according to claim 46, further comprising:
etching the substrate from a bottom surface to form an ink-feed hole extending through the substrate and dissolving the sacrificial mold through the ink feed-hole.

48. A method of fabricating an inkjet head, the method comprising:
preparing a photo-curable epoxy resin composition including a mixture of a difunctional epoxy resin, a multifunctional epoxy resin, a photo-radical generator, and a non-photo reactive solvent;
applying the photo-curable epoxy resin composition to a substrate to form a photo-curable resin layer;
exposing the photo-curable resin layer using a mask to cause a radical provided by the photo-radical generator to react with at least one of the difunctional epoxy resin and the multifunctional epoxy resin; and
removing an unexposed portion of the photo-curable resin layer.

49. The method according to claim 48, wherein removing the unexposed portion of the photo-curable resin layer comprises:
developing an exposed portion of the photo-curable resin layer using a developer; and
rinsing the photo-curable resin layer with an alcohol to remove the unexposed portion.

50. The method according to claim 48, further comprising:
before exposing the photo-curable resin layer, performing a pre-bake operation; and
after exposing the photo-curable resin layer, performing a post-bake operation.

51. A method of fabricating an ink jet head, the method comprising:
forming a chamber layer to define an ink flow path and a nozzle layer having one or more nozzles on a substrate having one or more pressure generating elements disposed thereon,
wherein at least one of the chamber layer and the nozzle layer is formed by a photo-curable resin composition containing a plurality of epoxy resins and a photo-radical generator to provide a radical that reacts with one or more radicals of the plurality of epoxy resin so that the plurality of epoxy resins are cross-linked.

52. An inkjet head comprising:
a substrate having one or more pressure generating elements disposed thereon; and
an ink flow structure disposed on the substrate including a chamber layer having ink chambers and an ink flow path and a nozzle layer having one or more nozzles corresponding to the one or more pressure generating elements, wherein at least one of the nozzle layer and the chamber layer is formed of at least one photo-curable resin layer containing a photo-radical generator, an epoxy resin curable by reaction with a radical, and a non-photo reactive solvent.

53. The inkjet head according to claim 52, wherein the nozzle layer and the chamber layer are separate structures and the chamber layer is formed of the at least one photo-curable resin layer.

54. The inkjet head according to claim 52, wherein the nozzle layer is formed by another of the at least one photo-curable resin layer.

55. The inkjet head according to claim 52, wherein the chamber layer and the nozzle layer is a composite structure formed of the at least one photo-curable resin layer.

56. The inkjet head according to claim 52, wherein the radical provided by the photo-radical generator reacts with an epoxy radical of the epoxy resin is exposed to a light.

57. The inkjet head according to claim 52, wherein the radical provided by the photo-radical generator reacts with an epoxy radical to cross link the epoxy resin creating a ring-opening polymerization.
